(19) United States
(12) Patent Application Publication
(10) Pub. No.: US 2023/0159063 A1
(43) Pub. Date: May 25, 2023

(54) Autonomous Driving Mode Engagement

(71) Applicant: Motional AD LLC, Boston, MA (US)

(72) Inventors: Jesse Adam Miller, Cambridge, MA (US); Eric Wolff, Boston, MA (US); Ning Wu, Singapore (SG)

(21) Appl. No.: 17/532,378

(22) Filed: Nov. 22, 2021

(51) Int. Cl. B60W 60/00; B60W 50/08; B60W 50/14; B60W 10/20

(52) U.S. Cl. CPC B60W 60/0061; B60W 60/0059; B60W 60/0053; B60W 60/0015; B60W 50/082; B60W 50/14; B60W 10/20; B60W 2050/0054

(57) ABSTRACT

Provided are methods for autonomous driving mode engagement. Some systems described receive at least one autonomous vehicle operation task output associated with driving a vehicle in autonomous driving mode in an environment while the vehicle is operated in manual driving mode in the environment. The at least one autonomous vehicle operation task output is compared to a respective threshold, wherein the respective threshold is adaptive based on a current operational state of the vehicle in the manual driving mode. A transition indicator is set based on the comparison, and a transition from the manual driving mode to the autonomous driving mode is rejected in response to the transition indicator indicating a smooth transition from the manual driving mode to the autonomous driving mode is unavailable. Methods and computer program products are also provided.

### BACKGROUND

Vehicles are operable in one or more modes. Modes of operation include autonomous driving modes, manual driving modes, and non-driving modes such as parked or disabled, or any other mode of operation or non-operation that occurs at the vehicle. Transitions occur between the various operational modes of a vehicle.

### BRIEF DESCRIPTION OF THE FIGURES

FIG. 1 is an example environment in which a vehicle including one or more components of an autonomous system can be implemented;

FIG. 2 is a diagram of one or more systems of a vehicle including an autonomous system;

FIG. 3 is a diagram of components of one or more devices and/or one or more systems of FIGS. 1 and 2;

FIG. 4 is a diagram of certain components of an autonomous system;

FIG. 5 is a diagram of an implementation of a process for autonomous driving mode engagement;

FIG. 6 is a block diagram of autonomous driving mode engagement;

FIG. 7 is a block diagram of an adaptive threshold generation system.

FIG. 8 is a block diagram of a process that enables autonomous driving mode engagement.

### DETAILED DESCRIPTION

In the following description numerous specific details are set forth in order to provide a thorough understanding of the present disclosure for the purposes of explanation. It will be apparent, however, that the embodiments described by the present disclosure can be practiced without these specific details. In some instances, well-known structures and devices are illustrated in block diagram form in order to avoid unnecessarily obscuring aspects of the present disclosure.

Specific arrangements or orderings of schematic elements, such as those representing systems, devices, modules, instruction blocks, data elements, and/or the like are illustrated in the drawings for ease of description. However, it will be understood by those skilled in the art that the specific ordering or arrangement of the schematic elements in the drawings is not meant to imply that a particular order or sequence of processing, or separation of processes, is required unless explicitly described as such. Further, the inclusion of a schematic element in a drawing is not meant to imply that such element is required in all embodiments or that the features represented by such element may not be included in or combined with other elements in some embodiments unless explicitly described as such.

Further, where connecting elements such as solid or dashed lines or arrows are used in the drawings to illustrate a connection, relationship, or association between or among two or more other schematic elements, the absence of any such connecting elements is not meant to imply that no connection, relationship, or association can exist. In other words, some connections, relationships, or associations between elements are not illustrated in the drawings so as not to obscure the disclosure. In addition, for ease of illustration, a single connecting element can be used to represent multiple connections, relationships or associations between elements. For example, where a connecting element represents communication of signals, data, or instructions (e.g., “software instructions”), it should be understood by those skilled in the art that such element can represent one or multiple signal paths (e.g., a bus), as may be needed, to affect the communication.

Although the terms first, second, third, and/or the like are used to describe various elements, these elements should not be limited by these terms. The terms first, second, third, and/or the like are used only to distinguish one element from another. For example, a first contact could be termed a second contact and, similarly, a second contact could be termed a first contact without departing from the scope of the described embodiments. The first contact and the second contact are both contacts, but they are not the same contact.

The terminology used in the description of the various described embodiments herein is included for the purpose of describing particular embodiments only and is not intended to be limiting. As used in the description of the various described embodiments and the appended claims, the singular forms “a,” “an” and “the” are intended to include the plural forms as well and can be used interchangeably with “one or more” or “at least one,” unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this description specify the presence of stated features, integers, steps, operations, elements, and/or components, but do not preclude the presence or addition of one or more other features, integers, steps, operations, elements, components, and/or groups thereof.

As used herein, the terms “communication” and “communicate” refer to at least one of the reception, receipt, transmission, transfer, provision, and/or the like of information (or information represented by, for example, data, signals, messages, instructions, commands, and/or the like). For one unit (e.g., a device, a system, a component of a device or system, combinations thereof, and/or the like) to be in communication with another unit means that the one unit is able to directly or indirectly receive information from and/or send (e.g., transmit) information to the other unit. This may refer to a direct or indirect connection that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit (e.g., a third unit located between the first unit and the second unit) processes information received from the first unit and transmits the processed information to the second unit. In some embodiments, a message may refer to a network packet (e.g., a data packet and/or the like) that includes data.

As used herein, the term “if” is, optionally, construed to mean “when”, “upon”, “in response to determining,” “in response to detecting,” and/or the like, depending on the context. Similarly, the phrase “if it is determined” or “if [a stated condition or event] is detected” is, optionally, construed to mean “upon determining,” “in response to determining,” “upon detecting [the stated condition or event],” “in response to detecting [the stated condition or event],” and/or the like, depending on the context. Also, as used herein, the terms “has”, “have”, “having”, or the like are intended to be open-ended terms. Further, the phrase “based on” is intended to mean “based at least partially on” unless explicitly stated otherwise.

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments can be practiced without these specific details. In other instances, well-known methods, procedures, components, circuits, and networks have not been described in detail so as not to unnecessarily obscure aspects of the embodiments.

General Overview

In some aspects and/or embodiments, systems, methods, and computer program products described herein include and/or implement autonomous driving mode engagement. A vehicle (such as an autonomous vehicle) has multiple operating modes with varying levels of autonomous functionality. In some cases, a vehicle enables both an autonomous driving mode and a manual driving mode. For example, in an autonomous driving mode, the vehicle navigates an environment without human assistance. In a manual driving mode, a human driver controls the vehicle as it navigates through the environment. Health information and task information (e.g., autonomous vehicle task outputs) are obtained for one or more autonomous vehicle tasks during manual driving mode. The health information and task information are compared to at least one adaptive threshold. A transition indicator is set based on the comparison, where the transition indicator signals that a smooth transition from a manual driving mode to an autonomous driving mode is available for the respective task. As a result, autonomous driving mode engagement is enabled. A transition from a manual driving mode to an autonomous driving mode is rejected when a smooth transition is unavailable for the respective task. When a smooth transition from a manual driving mode to an autonomous driving mode is not available, autonomous driving mode engagement is disabled. In embodiments, the availability of a transition into an autonomous driving mode is indicated by an autonomous ready (AutoReady) indicator.

By virtue of the implementation of systems, methods, and computer program products described herein, techniques for autonomous driving mode engagement provides a guided changeover between autonomous and manual vehicle operation. Some of the advantages of the autonomous driving mode engagement include a smooth and comfortable transition into an autonomous driving mode from a manual driving mode. This smoother and more comfortable transition both increases confidence in the capabilities of the vehicle's autonomous system. In addition, the resulting operation of the vehicle is more consistent, since, in the case where the vehicle transitions to an autonomous driving mode, such transition occurs based on an indication that the vehicle can perform such a transition with a predetermined degree of comfort to both individuals in the vehicle as well as outside the vehicle (e.g., pedestrians, in other vehicles, etc.). The present techniques also ensure that transitions into an autonomous driving mode are safe and stable. Moreover, the present techniques enable corrective actions to be taken to engage autonomous driving mode in response to an autonomous driving mode being unavailable.

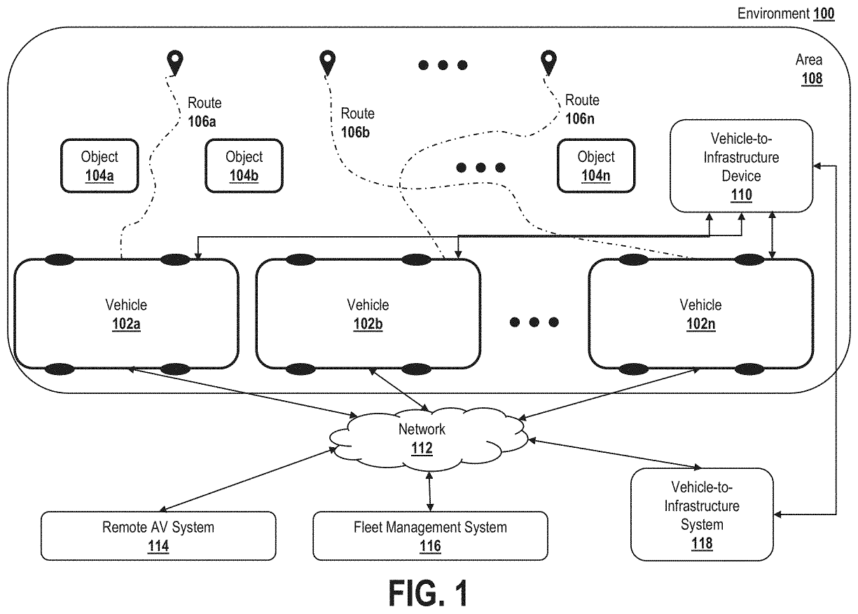

Referring now to FIG. 1, illustrated is example environment 100 in which vehicles that include autonomous systems, as well as vehicles that do not, are operated. As illustrated, environment 100 includes vehicles 102a-102n, objects 104a-104n, routes 106a-106n, area 108, vehicle-to-infrastructure (V2I) device 110, network 112, remote autonomous vehicle (AV) system 114, fleet management system 116, and V2I system 118. Vehicles 102a-102n, vehicle-to-infrastructure (V2I) device 110, network 112, autonomous vehicle (AV) system 114, fleet management system 116, and V2I system 118 interconnect (e.g., establish a connection to communicate and/or the like) via wired connections, wireless connections, or a combination of wired or wireless connections. In some embodiments, objects 104a-104n interconnect with at least one of vehicles 102a-102n, vehicle-to-infrastructure (V2I) device 110, network 112, autonomous vehicle (AV) system 114, fleet management system 116, and V2I system 118 via wired connections, wireless connections, or a combination of wired or wireless connections.

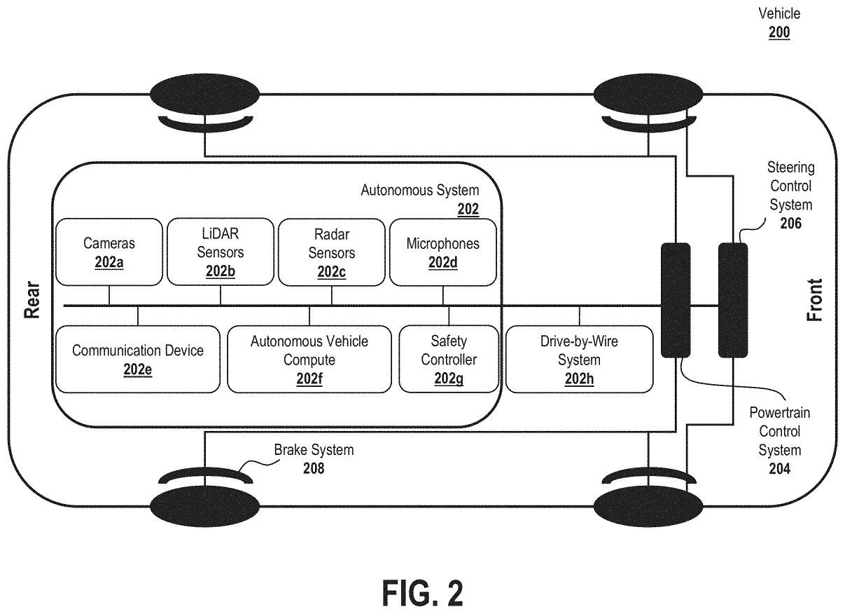

Vehicles 102a-102n (referred to individually as vehicle 102 and collectively as vehicles 102) include at least one device configured to transport goods and/or people. In some embodiments, vehicles 102 are configured to be in communication with V2I device 110, remote AV system 114, fleet management system 116, and/or V2I system 118 via network 112. In some embodiments, vehicles 102 include cars, buses, trucks, trains, and/or the like. In some embodiments, vehicles 102 are the same as, or similar to, vehicles 200, described herein (see FIG. 2). In some embodiments, a vehicle 200 of a set of vehicles 200 is associated with an autonomous fleet manager. In some embodiments, vehicles 102 travel along respective routes 106a-106n (referred to individually as route 106 and collectively as routes 106), as described herein. In some embodiments, one or more vehicles 102 include an autonomous system (e.g., an autonomous system that is the same as or similar to an autonomous system 202).

Objects 104a-104n (referred to individually as object 104 and collectively as objects 104) include, for example, at least one vehicle, at least one pedestrian, at least one cyclist, at least one structure (e.g., a building, a sign, a fire hydrant, etc.), and/or the like. Each object 104 is stationary (e.g., located at a fixed location for a period of time) or mobile (e.g., having a velocity and associated with at least one trajectory). In some embodiments, objects 104 are associated with corresponding locations in area 108.

Routes 106a-106n (referred to individually as route 106 and collectively as routes 106) are each associated with (e.g., prescribe) a sequence of actions (also known as a trajectory) connecting states along which an AV can navigate. Each route 106 starts at an initial state (e.g., a state that corresponds to a first spatiotemporal location, velocity, and/or the like) and a final goal state (e.g., a state that corresponds to a second spatiotemporal location that is different from the first spatiotemporal location) or goal region (e.g. a subspace of acceptable states (e.g., terminal states)). In some embodiments, the first state includes a location at which an individual or individuals are to be picked-up by the AV and the second state or region includes a location or locations at which the individual or individuals picked-up by the AV are to be dropped-off. In some embodiments, routes 106 include a plurality of acceptable state sequences (e.g., a plurality of spatiotemporal location sequences), the plurality of state sequences associated with (e.g., defining) a plurality of trajectories. In an example, routes 106 include only high level actions or imprecise state locations, such as a series of connected roads dictating turning directions at roadway intersections. Additionally, or alternatively, routes 106 may include more precise actions or states such as, for example, specific target lanes or precise locations within the lane areas and targeted speed at those positions. In an example, routes 106 include a plurality of precise state sequences along the at least one high level action sequence with a limited lookahead horizon to reach intermediate goals, where the combination of successive iterations of limited horizon state sequences cumulatively correspond to a plurality of trajectories that collectively form the high level route to terminate at the final goal state or region.

Area 108 includes a physical area (e.g., a geographic region) within which vehicles 102 can navigate. In an example, area 108 includes at least one state (e.g., a country, a province, an individual state of a plurality of states included in a country, etc.), at least one portion of a state, at least one city, at least one portion of a city, etc. In some embodiments, area 108 includes at least one named thoroughfare (referred to herein as a “road”) such as a highway, an interstate highway, a parkway, a city street, etc. Additionally, or alternatively, in some examples area 108 includes at least one unnamed road such as a driveway, a section of a parking lot, a section of a vacant and/or undeveloped lot, a dirt path, etc. In some embodiments, a road includes at least one lane (e.g., a portion of the road that can be traversed by vehicles 102). In an example, a road includes at least one lane associated with (e.g., identified based on) at least one lane marking.

Vehicle-to-Infrastructure (V2I) device 110 (sometimes referred to as a Vehicle-to-Infrastructure (V2X) device) includes at least one device configured to be in communication with vehicles 102 and/or V2I infrastructure system 118. In some embodiments, V2I device 110 is configured to be in communication with vehicles 102, remote AV system 114, fleet management system 116, and/or V2I system 118 via network 112. In some embodiments, V2I device 110 includes a radio frequency identification (RFID) device, signage, cameras (e.g., two-dimensional (2D) and/or three-dimensional (3D) cameras), lane markers, streetlights, parking meters, etc. In some embodiments, V2I device 110 is configured to communicate directly with vehicles 102. Additionally, or alternatively, in some embodiments V2I device 110 is configured to communicate with vehicles 102, remote AV system 114, and/or fleet management system 116 via V2I system 118. In some embodiments, V2I device 110 is configured to communicate with V2I system 118 via network 112.

Network 112 includes one or more wired and/or wireless networks. In an example, network 112 includes a cellular network (e.g., a long term evolution (LTE) network, a third generation (3G) network, a fourth generation (4G) network, a fifth generation (5G) network, a code division multiple access (CDMA) network, etc.), a public land mobile network (PLMN), a local area network (LAN), a wide area network (WAN), a metropolitan area network (MAN), a telephone network (e.g., the public switched telephone network (PSTN), a private network, an ad hoc network, an intranet, the Internet, a fiber optic-based network, a cloud computing network, etc., a combination of some or all of these networks, and/or the like.

Remote AV system 114 includes at least one device configured to be in communication with vehicles 102, V2I device 110, network 112, remote AV system 114, fleet management system 116, and/or V2I system 118 via network 112. In an example, remote AV system 114 includes a server, a group of servers, and/or other like devices. In some embodiments, remote AV system 114 is co-located with the fleet management system 116. In some embodiments, remote AV system 114 is involved in the installation of some or all of the components of a vehicle, including an autonomous system, an autonomous vehicle compute, software implemented by an autonomous vehicle compute, and/or the like. In some embodiments, remote AV system 114 maintains (e.g., updates and/or replaces) such components and/or software during the lifetime of the vehicle.

Fleet management system 116 includes at least one device configured to be in communication with vehicles 102, V2I device 110, remote AV system 114, and/or V2I infrastructure system 118. In an example, fleet management system 116 includes a server, a group of servers, and/or other like devices. In some embodiments, fleet management system 116 is associated with a ridesharing company (e.g., an organization that controls operation of multiple vehicles (e.g., vehicles that include autonomous systems and/or vehicles that do not include autonomous systems) and/or the like).

In some embodiments, V2I system 118 includes at least one device configured to be in communication with vehicles 102, V2I device 110, remote AV system 114, and/or fleet management system 116 via network 112. In some examples, V2I system 118 is configured to be in communication with V2I device 110 via a connection different from network 112. In some embodiments, V2I system 118 includes a server, a group of servers, and/or other like devices. In some embodiments, V2I system 118 is associated with a municipality or a private institution (e.g., a private institution that maintains V2I device 110 and/or the like).

The number and arrangement of elements illustrated in FIG. 1 are provided as an example. There can be additional elements, fewer elements, different elements, and/or differently arranged elements, than those illustrated in FIG. 1. Additionally, or alternatively, at least one element of environment 100 can perform one or more functions described as being performed by at least one different element of FIG. 1. Additionally, or alternatively, at least one set of elements of environment 100 can perform one or more functions described as being performed by at least one different set of elements of environment 100.

Referring now to FIG. 2, vehicle 200 includes autonomous system 202, powertrain control system 204, steering control system 206, and brake system 208. In some embodiments, vehicle 200 is the same as or similar to vehicle 102 (see FIG. 1). In some embodiments, vehicle 102 have autonomous capability (e.g., implement at least one function, feature, device, and/or the like that enable vehicle 200 to be partially or fully operated without human intervention including, without limitation, fully autonomous vehicles (e.g., vehicles that forego reliance on human intervention), highly autonomous vehicles (e.g., vehicles that forego reliance on human intervention in certain situations), and/or the like). For a detailed description of fully autonomous vehicles and highly autonomous vehicles, reference may be made to SAE International's standard J3016: Taxonomy and Definitions for Terms Related to On-Road Motor Vehicle Automated Driving Systems, which is incorporated by reference in its entirety. In some embodiments, vehicle 200 is associated with an autonomous fleet manager and/or a ridesharing company. Generally, the vehicle 200 includes systems, sensors, devices, and controllers that generate data associated with various tasks (e.g., autonomous vehicle operation task output). In some cases, the tasks implement at least one function, feature, device, and/or the like that enable vehicle 200 to be partially or fully operated without human intervention including, without limitation, fully autonomous vehicles (e.g., vehicles that forego reliance on human intervention).

Autonomous system 202 includes a sensor suite that includes one or more devices such as cameras 202a, LiDAR sensors 202b, radar sensors 202c, and microphones 202d. In some embodiments, autonomous system 202 can include more or fewer devices and/or different devices (e.g., ultrasonic sensors, inertial sensors, GPS receivers (discussed below), odometry sensors that generate data associated with an indication of a distance that vehicle 200 has traveled, and/or the like). In some embodiments, autonomous system 202 uses the one or more devices included in autonomous system 202 to generate data associated with environment 100, described herein. The data generated by the one or more devices of autonomous system 202 can be used by one or more systems described herein to observe the environment (e.g., environment 100) in which vehicle 200 is located. In some embodiments, autonomous system 202 includes communication device 202e, autonomous vehicle compute 202f, and drive-by-wire (DBW) system 202h.

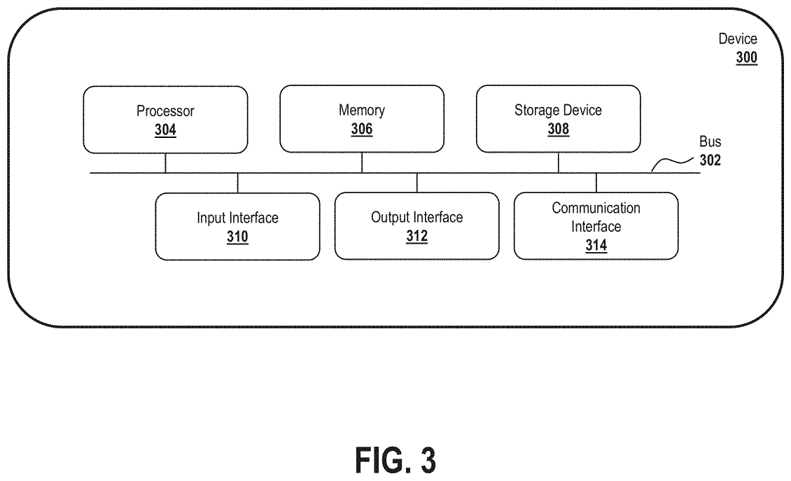

Cameras 202a include at least one device configured to be in communication with communication device 202e, autonomous vehicle compute 202f, and/or safety controller 202g via a bus (e.g., a bus that is the same as or similar to bus 302 of FIG. 3). Cameras 202a include at least one camera (e.g., a digital camera using a light sensor such as a charge-coupled device (CCD), a thermal camera, an infrared (IR) camera, an event camera, and/or the like) to capture images including physical objects (e.g., cars, buses, curbs, people, and/or the like). In some embodiments, camera 202a generates camera data as output. In some examples, camera 202a generates camera data that includes image data associated with an image. In this example, the image data may specify at least one parameter (e.g., image characteristics such as exposure, brightness, etc., an image timestamp, and/or the like) corresponding to the image. In such an example, the image may be in a format (e.g., RAW, JPEG, PNG, and/or the like). In some embodiments, camera 202a includes a plurality of independent cameras configured on (e.g., positioned on) a vehicle to capture images for the purpose of stereopsis (stereo vision). In some examples, camera 202a includes a plurality of cameras that generate image data and transmit the image data to an autonomous vehicle compute 202f and/or a fleet management system (e.g., a fleet management system that is the same as or similar to fleet management system 116 of FIG. 1). In such an example, autonomous vehicle compute 202f determines depth to one or more objects in a field of view of at least two cameras of the plurality of cameras based on the image data from the at least two cameras. In some embodiments, cameras 202a is configured to capture images of objects within a distance from cameras 202a (e.g., up to 100 meters, up to a kilometer, and/or the like). Accordingly, cameras 202a include features such as sensors and lenses that are optimized for perceiving objects that are at one or more distances from cameras 202a.

In an embodiment, camera 202a includes at least one camera configured to capture one or more images associated with one or more traffic lights, street signs and/or other physical objects that provide visual navigation information. In some embodiments, camera 202a generates traffic light data associated with one or more images. In some examples, camera 202a generates TLD data associated with one or more images that include a format (e.g., RAW, JPEG, PNG, and/or the like). In some embodiments, camera 202a that generates TLD data differs from other systems described herein incorporating cameras in that camera 202a can include one or more cameras with a wide field of view (e.g., a wide-angle lens, a fish-eye lens, a lens having a viewing angle of approximately 120 degrees or more, and/or the like) to generate images about as many physical objects as possible.

Laser Detection and Ranging (LiDAR) sensors 202b include at least one device configured to be in communication with communication device 202e, autonomous vehicle compute 202f, and/or safety controller 202g via a bus (e.g., a bus that is the same as or similar to bus 302 of FIG. 3). LiDAR sensors 202b include a system configured to transmit light from a light emitter (e.g., a laser transmitter). Light emitted by LiDAR sensors 202b include light (e.g., infrared light and/or the like) that is outside of the visible spectrum. In some embodiments, during operation, light emitted by LiDAR sensors 202b encounters a physical object (e.g., a vehicle) and is reflected back to LiDAR sensors 202b. In some embodiments, the light emitted by LiDAR sensors 202b does not penetrate the physical objects that the light encounters. LiDAR sensors 202b also include at least one light detector which detects the light that was emitted from the light emitter after the light encounters a physical object. In some embodiments, at least one data processing system associated with LiDAR sensors 202b generates an image (e.g., a point cloud, a combined point cloud, and/or the like) representing the objects included in a field of view of LiDAR sensors 202b. In some examples, the at least one data processing system associated with LiDAR sensor 202b generates an image that represents the boundaries of a physical object, the surfaces (e.g., the topology of the surfaces) of the physical object, and/or the like. In such an example, the image is used to determine the boundaries of physical objects in the field of view of LiDAR sensors 202b.

Radio Detection and Ranging (radar) sensors 202c include at least one device configured to be in communication with communication device 202e, autonomous vehicle compute 202f, and/or safety controller 202g via a bus (e.g., a bus that is the same as or similar to bus 302 of FIG. 3). Radar sensors 202c include a system configured to transmit radio waves (either pulsed or continuously). The radio waves transmitted by radar sensors 202c include radio waves that are within a predetermined spectrum. In some embodiments, during operation, radio waves transmitted by radar sensors 202c encounter a physical object and are reflected back to radar sensors 202c. In some embodiments, the radio waves transmitted by radar sensors 202c are not reflected by some objects. In some embodiments, at least one data processing system associated with radar sensors 202c generates signals representing the objects included in a field of view of radar sensors 202c. For example, the at least one data processing system associated with radar sensor 202c generates an image that represents the boundaries of a physical object, the surfaces (e.g., the topology of the surfaces) of the physical object, and/or the like. In some examples, the image is used to determine the boundaries of physical objects in the field of view of radar sensors 202c.

Microphones 202d includes at least one device configured to be in communication with communication device 202e, autonomous vehicle compute 202f, and/or safety controller 202g via a bus (e.g., a bus that is the same as or similar to bus 302 of FIG. 3). Microphones 202d include one or more microphones (e.g., array microphones, external microphones, and/or the like) that capture audio signals and generate data associated with (e.g., representing) the audio signals. In some examples, microphones 202d include transducer devices and/or like devices. In some embodiments, one or more systems described herein can receive the data generated by microphones 202d and determine a position of an object relative to vehicle 200 (e.g., a distance and/or the like) based on the audio signals associated with the data.

Communication device 202e include at least one device configured to be in communication with cameras 202a, LiDAR sensors 202b, radar sensors 202c, microphones 202d, autonomous vehicle compute 202f, safety controller 202g, and/or DBW system 202h. For example, communication device 202e may include a device that is the same as or similar to communication interface 314 of FIG. 3. In some embodiments, communication device 202e includes a vehicle-to-vehicle (V2V) communication device (e.g., a device that enables wireless communication of data between vehicles).

Autonomous vehicle compute 202f include at least one device configured to be in communication with cameras 202a, LiDAR sensors 202b, radar sensors 202c, microphones 202d, communication device 202e, safety controller 202g, and/or DBW system 202h. In some examples, autonomous vehicle compute 202f includes a device such as a client device, a mobile device (e.g., a cellular telephone, a tablet, and/or the like) a server (e.g., a computing device including one or more central processing units, graphical processing units, and/or the like), and/or the like. In some embodiments, autonomous vehicle compute 202f is the same as or similar to an autonomous vehicle compute 400, described herein. Additionally, or alternatively, in some embodiments autonomous vehicle compute 202f is configured to be in communication with an autonomous vehicle system (e.g., an autonomous vehicle system that is the same as or similar to remote AV system 114 of FIG. 1), a fleet management system (e.g., a fleet management system that is the same as or similar to fleet management system 116 of FIG. 1), a V2I device (e.g., a V2I device that is the same as or similar to V2I device 110 of FIG. 1), and/or a V2I system (e.g., a V2I system that is the same as or similar to V2I system 118 of FIG. 1).

Safety controller 202g includes at least one device configured to be in communication with cameras 202a, LiDAR sensors 202b, radar sensors 202c, microphones 202d, communication device 202e, autonomous vehicle computer 202f, and/or DBW system 202h. In some examples, safety controller 202g includes one or more controllers (electrical controllers, electromechanical controllers, and/or the like) that are configured to generate and/or transmit control signals to operate one or more devices of vehicle 200 (e.g., powertrain control system 204, steering control system 206, brake system 208, and/or the like). In some embodiments, safety controller 202g is configured to generate control signals that take precedence over (e.g., overrides) control signals generated and/or transmitted by autonomous vehicle compute 202f.

DBW system 202h includes at least one device configured to be in communication with communication device 202e and/or autonomous vehicle compute 202f. In some examples, DBW system 202h includes one or more controllers (e.g., electrical controllers, electromechanical controllers, and/or the like) that are configured to generate and/or transmit control signals to operate one or more devices of vehicle 200 (e.g., powertrain control system 204, steering control system 206, brake system 208, and/or the like). Additionally, or alternatively, the one or more controllers of DBW system 202h are configured to generate and/or transmit control signals to operate at least one different device (e.g., a turn signal, headlights, door locks, windshield wipers, and/or the like) of vehicle 200.

Powertrain control system 204 includes at least one device configured to be in communication with DBW system 202h. In some examples, powertrain control system 204 includes at least one controller, actuator, and/or the like. In some embodiments, powertrain control system 204 receives control signals from DBW system 202h and powertrain control system 204 causes vehicle 200 to start moving forward, stop moving forward, start moving backward, stop moving backward, accelerate in a direction, decelerate in a direction, perform a left turn, perform a right turn, and/or the like. In an example, powertrain control system 204 causes the energy (e.g., fuel, electricity, and/or the like) provided to a motor of the vehicle to increase, remain the same, or decrease, thereby causing at least one wheel of vehicle 200 to rotate or not rotate.

Steering control system 206 includes at least one device configured to rotate one or more wheels of vehicle 200. In some examples, steering control system 206 includes at least one controller, actuator, and/or the like. In some embodiments, steering control system 206 causes the front two wheels and/or the rear two wheels of vehicle 200 to rotate to the left or right to cause vehicle 200 to turn to the left or right.

Brake system 208 includes at least one device configured to actuate one or more brakes to cause vehicle 200 to reduce speed and/or remain stationary. In some examples, brake system 208 includes at least one controller and/or actuator that is configured to cause one or more calipers associated with one or more wheels of vehicle 200 to close on a corresponding rotor of vehicle 200. Additionally, or alternatively, in some examples brake system 208 includes an automatic emergency braking (AEB) system, a regenerative braking system, and/or the like.

In some embodiments, vehicle 200 includes at least one platform sensor (not explicitly illustrated) that measures or infers properties of a state or a condition of vehicle 200. In some examples, vehicle 200 includes platform sensors such as a global positioning system (GPS) receiver, an inertial measurement unit (IMU), a wheel speed sensor, a wheel brake pressure sensor, a wheel torque sensor, an engine torque sensor, a steering angle sensor, and/or the like.

Referring now to FIG. 3, illustrated is a schematic diagram of a device 300. As illustrated, device 300 includes processor 304, memory 306, storage component 308, input interface 310, output interface 312, communication interface 314, and bus 302. In some embodiments, device 300 corresponds to at least one device of vehicles 102 (e.g., at least one device of a system of vehicles 102) and/or one or more devices of network 112 (e.g., one or more devices of a system of network 112). In some embodiments, one or more devices of vehicles 102 (e.g., one or more devices of a system of vehicles 102) and/or one or more devices of network 112 (e.g., one or more devices of a system of network 112) include at least one device 300 and/or at least one component of device 300. As shown in FIG. 3, device 300 includes bus 302, processor 304, memory 306, storage component 308, input interface 310, output interface 312, and communication interface 314.

Bus 302 includes a component that permits communication among the components of device 300. In some embodiments, processor 304 is implemented in hardware, software, or a combination of hardware and software. In some examples, processor 304 includes a processor (e.g., a central processing unit (CPU), a graphics processing unit (GPU), an accelerated processing unit (APU), and/or the like), a microphone, a digital signal processor (DSP), and/or any processing component (e.g., a field-programmable gate array (FPGA), an application specific integrated circuit (ASIC), and/or the like) that can be programmed to perform at least one function. Memory 306 includes random access memory (RAM), read-only memory (ROM), and/or another type of dynamic and/or static storage device (e.g., flash memory, magnetic memory, optical memory, and/or the like) that stores data and/or instructions for use by processor 304.

Storage component 308 stores data and/or software related to the operation and use of device 300. In some examples, storage component 308 includes a hard disk (e.g., a magnetic disk, an optical disk, a magneto-optic disk, a solid state disk, and/or the like), a compact disc (CD), a digital versatile disc (DVD), a floppy disk, a cartridge, a magnetic tape, a CD-ROM, RAM, PROM, EPROM, FLASH-EPROM, NV-RAM, and/or another type of computer readable medium, along with a corresponding drive.

Input interface 310 includes a component that permits device 300 to receive information, such as via user input (e.g., a touchscreen display, a keyboard, a keypad, a mouse, a button, a switch, a microphone, a camera, and/or the like). Additionally or alternatively, in some embodiments input interface 310 includes a sensor that senses information (e.g., a global positioning system (GPS) receiver, an accelerometer, a gyroscope, an actuator, and/or the like). Output interface 312 includes a component that provides output information from device 300 (e.g., a display, a speaker, one or more light-emitting diodes (LEDs), and/or the like).

In some embodiments, communication interface 314 includes a transceiver-like component (e.g., a transceiver, a separate receiver and transmitter, and/or the like) that permits device 300 to communicate with other devices via a wired connection, a wireless connection, or a combination of wired and wireless connections. In some examples, communication interface 314 permits device 300 to receive information from another device and/or provide information to another device. In some examples, communication interface 314 includes an Ethernet interface, an optical interface, a coaxial interface, an infrared interface, a radio frequency (RF) interface, a universal serial bus (USB) interface, a Wi-Fi® interface, a cellular network interface, and/or the like.

In some embodiments, device 300 performs one or more processes described herein. Device 300 performs these processes based on processor 304 executing software instructions stored by a computer-readable medium, such as memory 305 and/or storage component 308. A computer-readable medium (e.g., a non-transitory computer readable medium) is defined herein as a non-transitory memory device. A non-transitory memory device includes memory space located inside a single physical storage device or memory space spread across multiple physical storage devices.

In some embodiments, software instructions are read into memory 306 and/or storage component 308 from another computer-readable medium or from another device via communication interface 314. When executed, software instructions stored in memory 306 and/or storage component 308 cause processor 304 to perform one or more processes described herein. Additionally or alternatively, hardwired circuitry is used in place of or in combination with software instructions to perform one or more processes described herein. Thus, embodiments described herein are not limited to any specific combination of hardware circuitry and software unless explicitly stated otherwise.

Memory 306 and/or storage component 308 includes data storage or at least one data structure (e.g., a database and/or the like). Device 300 is capable of receiving information from, storing information in, communicating information to, or searching information stored in the data storage or the at least one data structure in memory 306 or storage component 308. In some examples, the information includes network data, input data, output data, or any combination thereof.

In some embodiments, device 300 is configured to execute software instructions that are either stored in memory 306 and/or in the memory of another device (e.g., another device that is the same as or similar to device 300). As used herein, the term “module” refers to at least one instruction stored in memory 306 and/or in the memory of another device that, when executed by processor 304 and/or by a processor of another device (e.g., another device that is the same as or similar to device 300) cause device 300 (e.g., at least one component of device 300) to perform one or more processes described herein. In some embodiments, a module is implemented in software, firmware, hardware, and/or the like.

The number and arrangement of components illustrated in FIG. 3 are provided as an example. In some embodiments, device 300 can include additional components, fewer components, different components, or differently arranged components than those illustrated in FIG. 3. Additionally or alternatively, a set of components (e.g., one or more components) of device 300 can perform one or more functions described as being performed by another component or another set of components of device 300.

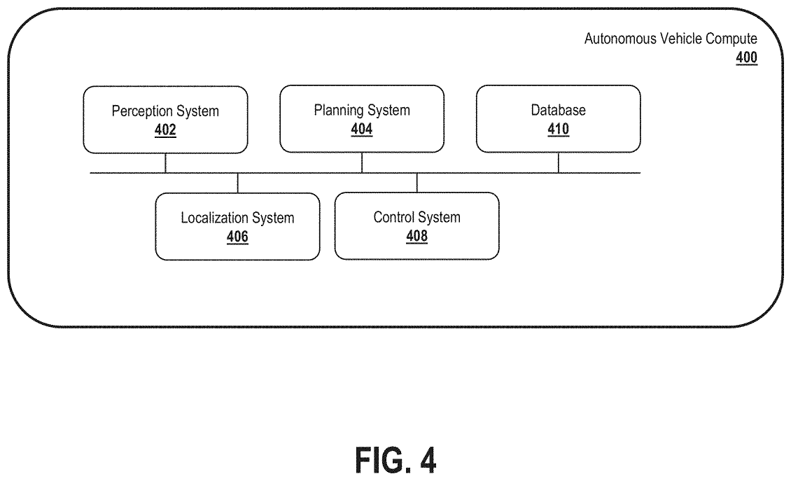

Referring now to FIG. 4, illustrated is an example block diagram of an autonomous vehicle compute 400 (sometimes referred to as an “AV stack”). As illustrated, autonomous vehicle compute 400 includes perception system 402 (sometimes referred to as a perception module), planning system 404 (sometimes referred to as a planning module), localization system 406 (sometimes referred to as a localization module), control system 408 (sometimes referred to as a control module), and database 410. In some embodiments, perception system 402, planning system 404, localization system 406, control system 408, and database 410 are included and/or implemented in an autonomous navigation system of a vehicle (e.g., autonomous vehicle compute 202f of vehicle 200). Additionally, or alternatively, in some embodiments perception system 402, planning system 404, localization system 406, control system 408, and database 410 are included in one or more standalone systems (e.g., one or more systems that are the same as or similar to an autonomous vehicle compute 400 and/or the like). In some examples, perception system 402, planning system 404, localization system 406, control system 408, and database 410 are included in one or more standalone systems that are located in a vehicle and/or at least one remote system as described herein. In some embodiments, any and/or all of the systems included in autonomous vehicle compute 400 are implemented in software (e.g., in software instructions stored in memory), computer hardware (e.g., by microprocessors, microcontrollers, application-specific integrated circuits [ASICs], Field Programmable Gate Arrays (FPGAs), and/or the like), or combinations of computer software and computer hardware. It will also be understood that, in some embodiments, autonomous vehicle compute 400 is configured to be in communication with a remote system (e.g., an autonomous vehicle system that is the same as or similar to remote AV system 114, a fleet management system 116 that is the same as or similar to fleet management system 116, a V2I system that is the same as or similar to V2I system 118, and/or the like). Moreover, in embodiments, the perception system 402, planning system 404, localization system 406, control system 408, and database 410 generate data associated with at least one autonomous vehicle operation task.

In some embodiments, perception system 402 receives data associated with at least one physical object (e.g., data that is used by perception system 402 to detect the at least one physical object) in an environment and classifies the at least one physical object. In some examples, perception system 402 receives image data captured by at least one camera (e.g., cameras 202a), the image associated with (e.g., representing) one or more physical objects within a field of view of the at least one camera. In such an example, perception system 402 classifies at least one physical object based on one or more groupings of physical objects (e.g., bicycles, vehicles, traffic signs, pedestrians, and/or the like). In some embodiments, perception system 402 transmits data associated with the classification of the physical objects to planning system 404 based on perception system 402 classifying the physical objects. In examples, the classification data output by the perception data 402 is an autonomous vehicle operation task output that enables setting a transition indicator as described below. In embodiments, the transition indicator is an autonomous ready (AutoReady) indicator associated with the autonomous functionality of the AV.

In some embodiments, planning system 404 receives data associated with a destination and generates data associated with at least one route (e.g., routes 106) along which a vehicle (e.g., vehicles 102) can travel along toward a destination. In some embodiments, planning system 404 periodically or continuously receives data from perception system 402 (e.g., data associated with the classification of physical objects, described above) and planning system 404 updates the at least one trajectory or generates at least one different trajectory based on the data generated by perception system 402. In some embodiments, planning system 404 receives data associated with an updated position of a vehicle (e.g., vehicles 102) from localization system 406 and planning system 404 updates the at least one trajectory or generates at least one different trajectory based on the data generated by localization system 406. In some embodiments, the output of the planning system is data associated with path planning. For example, an update to at least one trajectory or generation of at least one different trajectory based on the data generated by perception system is at least one autonomous vehicle operation task output that enables setting a transition indicator as described below.

In some embodiments, localization system 406 receives data associated with (e.g., representing) a location of a vehicle (e.g., vehicles 102) in an area. In some examples, localization system 406 receives LiDAR data associated with at least one point cloud generated by at least one LiDAR sensor (e.g., LiDAR sensors 202b). In certain examples, localization system 406 receives data associated with at least one point cloud from multiple LiDAR sensors and localization system 406 generates a combined point cloud based on each of the point clouds. In these examples, localization system 406 compares the at least one point cloud or the combined point cloud to a two-dimensional (2D) and/or a three-dimensional (3D) map of the area stored in database 410. Localization system 406 then determines the position of the vehicle in the area based on localization system 406 comparing the at least one point cloud or the combined point cloud to the map. In some embodiments, the map includes a combined point cloud of the area generated prior to navigation of the vehicle. In some embodiments, maps include, without limitation, high-precision maps of the roadway geometric properties, maps describing road network connectivity properties, maps describing roadway physical properties (such as traffic speed, traffic volume, the number of vehicular and cyclist traffic lanes, lane width, lane traffic directions, or lane marker types and locations, or combinations thereof), and maps describing the spatial locations of road features such as crosswalks, traffic signs or other travel signals of various types. In some embodiments, the map is generated in real-time based on the data received by the perception system.

In another example, localization system 406 receives Global Navigation Satellite System (GNSS) data generated by a global positioning system (GPS) receiver. In some examples, localization system 406 receives GNSS data associated with the location of the vehicle in the area and localization system 406 determines a latitude and longitude of the vehicle in the area. In such an example, localization system 406 determines the position of the vehicle in the area based on the latitude and longitude of the vehicle. In some embodiments, localization system 406 generates data associated with the position of the vehicle. In some examples, localization system 406 generates data associated with the position of the vehicle based on localization system 406 determining the position of the vehicle. In such an example, the data associated with the position of the vehicle includes data associated with one or more semantic properties corresponding to the position of the vehicle. In embodiments, the localization system 406 provides at least one autonomous vehicle operation task output that enables setting a transition indicator as described below. The localization system outputs one or more locations that are compared to an expected position to determine that a transition from the manual driving mode to the autonomous driving mode according to localization data is smooth.

In some embodiments, control system 408 receives data associated with at least one trajectory from planning system 404 and control system 408 controls operation of the vehicle. In some examples, control system 408 receives data associated with at least one trajectory from planning system 404 and control system 408 controls operation of the vehicle by generating and transmitting control signals to cause a powertrain control system (e.g., DBW system 202h, powertrain control system 204, and/or the like), a steering control system (e.g., steering control system 206), and/or a brake system (e.g., brake system 208) to operate. In an example, where a trajectory includes a left turn, control system 408 transmits a control signal to cause steering control system 206 to adjust a steering angle of vehicle 200, thereby causing vehicle 200 to turn left. Additionally, or alternatively, control system 408 generates and transmits control signals to cause other devices (e.g., headlights, turn signal, door locks, windshield wipers, and/or the like) of vehicle 200 to change states. In embodiments, the DBW system 202h, powertrain control system 204, steering control system 206, brake system 208 and the like generate at least one autonomous vehicle operation task output that enables setting a transition indicator as described below. In embodiments, the control system 408 outputs control signals that are compared to determine that a transition from the manual driving mode to the autonomous driving mode according to the control signals is smooth.

In some embodiments, perception system 402, planning system 404, localization system 406, and/or control system 408 implement at least one machine learning model (e.g., at least one multilayer perceptron (MLP), at least one convolutional neural network (CNN), at least one recurrent neural network (RNN), at least one autoencoder, at least one transformer, and/or the like). In some examples, perception system 402, planning system 404, localization system 406, and/or control system 408 implement at least one machine learning model alone or in combination with one or more of the above-noted systems. In some examples, perception system 402, planning system 404, localization system 406, and/or control system 408 implement at least one machine learning model as part of a pipeline (e.g., a pipeline for identifying one or more objects located in an environment and/or the like).

Database 410 stores data that is transmitted to, received from, and/or updated by perception system 402, planning system 404, localization system 406 and/or control system 408. In some examples, database 410 includes a storage component (e.g., a storage component that is the same as or similar to storage component 308 of FIG. 3) that stores data and/or software related to the operation and uses at least one system of autonomous vehicle compute 400. In some embodiments, database 410 stores data associated with 2D and/or 3D maps of at least one area. In some examples, database 410 stores data associated with 2D and/or 3D maps of a portion of a city, multiple portions of multiple cities, multiple cities, a county, a state, a State (e.g., a country), and/or the like). In such an example, a vehicle (e.g., a vehicle that is the same as or similar to vehicles 102 and/or vehicle 200) can drive along one or more drivable regions (e.g., single-lane roads, multi-lane roads, highways, back roads, off road trails, and/or the like) and cause at least one LiDAR sensor (e.g., a LiDAR sensor that is the same as or similar to LiDAR sensors 202b) to generate data associated with an image representing the objects included in a field of view of the at least one LiDAR sensor. In some embodiments, the database 410 stores data associated with autonomous vehicle operation task outputs.

In some embodiments, database 410 can be implemented across a plurality of devices. In some examples, database 410 is included in a vehicle (e.g., a vehicle that is the same as or similar to vehicles 102 and/or vehicle 200), an autonomous vehicle system (e.g., an autonomous vehicle system that is the same as or similar to remote AV system 114, a fleet management system (e.g., a fleet management system that is the same as or similar to fleet management system 116 of FIG. 1, a V2I system (e.g., a V2I system that is the same as or similar to V2I system 118 of FIG. 1) and/or the like.

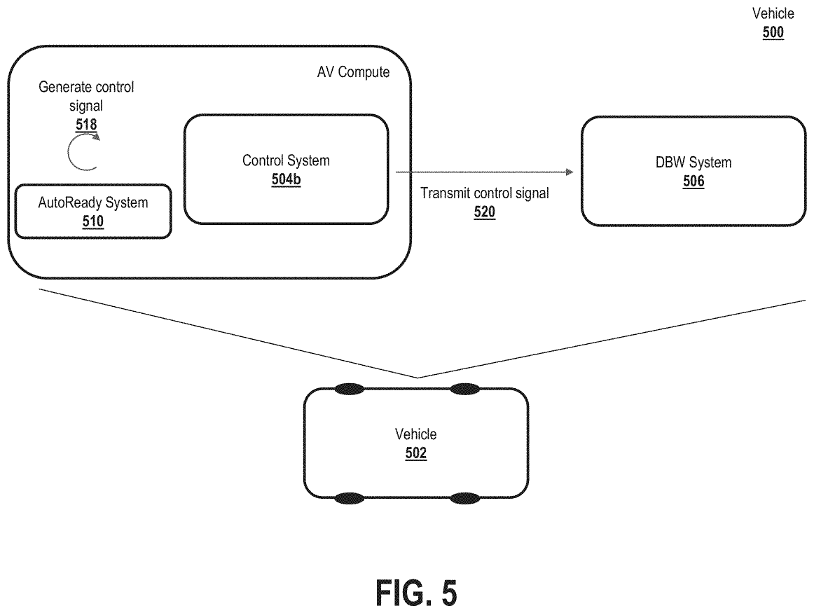

Referring now to FIG. 5, illustrated are diagrams of an implementation 500 of a process for autonomous driving mode engagement. In some embodiments, implementation 500 includes an AutoReady system 510 and a control system 504b. In some embodiments, control system 504b is the same as or similar to control system 408. A control signal 518 is generated in response to data received from systems, sensors, devices, and controllers that generate data associated with various tasks, such as the systems, sensors, devices, and controllers illustrated in FIG. 2.

In embodiments, the AutoReady system 510 applies an adaptive threshold to an autonomous vehicle operation task output. For example, a transition from a manual driving mode to an autonomous driving mode can produce uncommon or unsafe behavior. In particular, transitions from manual to autonomous driving modes can sometimes produce sudden accelerations, decelerations, or swerves. To prevent this, the present techniques poll autonomous vehicle operation tasks to determine a respective health of the autonomous vehicle operation task and an output quality of the autonomous vehicle operation task. The health and output quality are used to determine whether autonomous driving modes are allowed to engage, thereby creating an AutoReady check prior to transitions into an autonomous driving mode from a manual driving mode. If the AutoReady check fails, a reason for this failure can is communicated to a human, enabling the human to resolve the issue and make another attempt to engage autonomous driving mode. In embodiments, the human is a driver of the vehicle that operates the vehicle from within the vehicle. In embodiments, the human is a remote operator of the vehicle that operates the vehicle at a remote location with respect to the vehicle.

The adaptive threshold applied to an autonomous vehicle operation task output is based on, at least in part, a current state of the autonomous vehicle operation task. For example, when a vehicle is operating in manual driving mode at a speed of 60 kilometers per hour (km/hr), an adaptive threshold is a range of 58 km/hr-62 km/hr. In this example, autonomous vehicle functionality is available for engagement when the autonomous system (e.g., autonomous system 202) take control of the vehicle within a range of 58 km/hr-62 km/hr. When the vehicle is operating in manual driving mode at a speed of 20 km/hr, an exemplary adaptive threshold is a range of 15 km/hr-25 km/hr. In this example, autonomous vehicle functionality is available for engagement when the autonomous system (e.g., autonomous system 202) take control the vehicle within a range of 15 km/hr-25 km/hr. In this example, the adaptive threshold enables a larger range of speeds at which autonomous vehicle operation can engage (e.g., take control of manual driving) when the vehicle travels at a lower rate of speed. Generally, humans tolerate larger changes in speed at lower rates of travel. Thus, the adaptive threshold enables larger differences in speeds needed for engagement at lower rates of travel.

In some embodiments, an autonomous system (e.g., autonomous system 202) enables AV operation in a fully autonomous driving mode. The autonomous system also enables the AV systems to be operated in, for example, a fully manual driving mode. The present techniques are generally applicable to mixed-mode driving and mixed-mode driving systems, at least some implementations of which offer an option of being driven in a fully or partially autonomous driving mode or in a fully or partially manual driving mode. In some implementations, the mixed-mode driving may at times allow the occupant to drive manually. In some instances of mixed-mode driving, the AV system may permit the occupant to engage in one or more or a combination of driving modes. In some cases, the AV system may require the occupant or the AV or both to engage only in one or more particular driving modes, while precluding one or more selected other driving modes.

In some implementations, the AV system with mixed-mode driving capabilities may permit or require a transition of its driving mode from one to another. The transition may be based on automatic detection, an occupant request, or a server command, or combinations of them. The flexibility of driving mode transition of an AV system offers more options for an AV system user and provides a more efficient usage of the AV system. In embodiments, a mixed-mode driving system (e.g., one or more AV systems that permit or require mixed-mode driving) includes one or more AVs and the AV systems of which they are part (we sometimes use the terms “AV” and “AV system” interchangeably although in some implementations, the AV is only a part of an AV system).

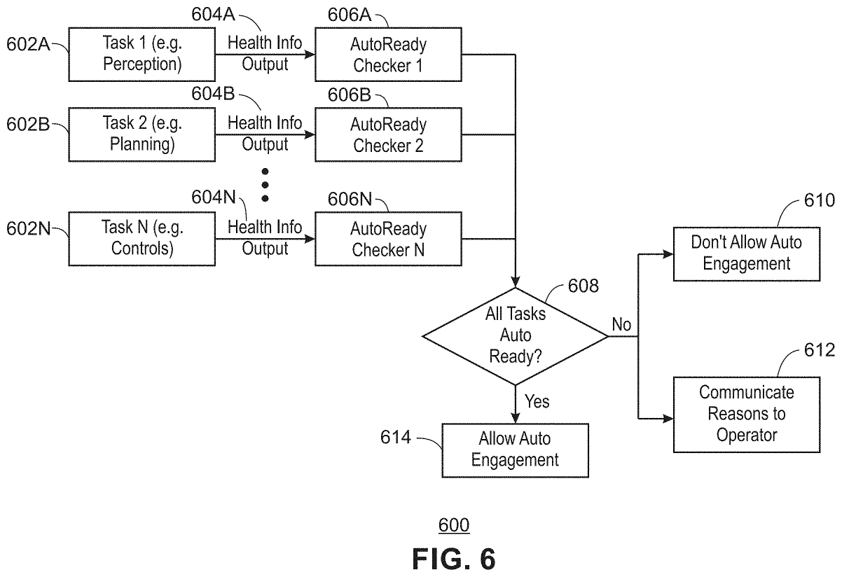

FIG. 6 is a block diagram of autonomous driving mode engagement at an AutoReady system 600. In the example of FIG. 6, a task 602A, task 602B, . . . , task 602N (collectively referred to as tasks 602) are illustrated. Additionally, an AutoReady checker 606A, AutoReady checker 606B, . . . , AutoReady checker 606N (collectively referred to as AutoReady checkers 606) are illustrated. In the example of FIG. 6, each of the tasks 602 outputs a respective output 604A, output 604B, . . . , output 604C (collectively referred to as output 604 or autonomous vehicle operation task output 604). In examples, the output 604 includes respective health information and autonomous vehicle task output.

In examples, an autonomous vehicle operates by executing one or more tasks 602. Tasks include, for example, perception, planning, controls, and the like. The tasks 602 execute separately of other tasks 602. Each task 602 has associated health information and output. The task health information and the outputs of each task are separately transmitted to a respective AutoReady checker 606. At block 608, if evaluation of the outputs 604 at the AutoReady checkers 606 indicates that a transition to an autonomous driving mode is available, then autonomous driving mode engagement is enabled. If all of the tasks do not indicate a transition to an autonomous driving mode is available, auto engagement is not enabled at block 610 and reasons for not enabling auto engagement are communicated to a driver or operator at block 612. The reasons for not allowing auto engagement are communicated to the driver or operator as a form of mitigation, and enables the driver or operator to take corrective actions that enable the availability of autonomous driving modes.

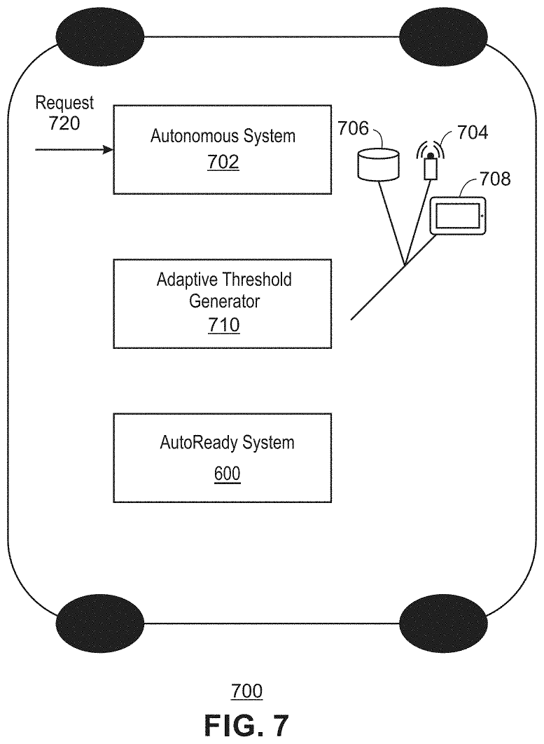

Generally, autonomous vehicle operation task output is generated by the autonomous system. The autonomous vehicle operation task output includes, for example, data associated with autonomous system information and data, an abnormal condition, or a request. The output 604 for each task is independently evaluated at a respective AutoReady checker 606. In embodiments, the output 604 for each task is evaluated using one or more adaptive thresholds generated based on a current operational state of the AV as described with respect to FIG. 7. The results of evaluation of the outputs 604 by the AutoReady checker 606 are then aggregated.

In examples, the output 604 is a status message that communicates an availability of a transition into an autonomous driving mode. In embodiments, the tasks 602 selected for evaluation prior to an autonomous driving mode engagement are based on a desired sensitivity of the autonomous driving mode engagement system. In embodiments, the output 604 communicates a measure of the health of an algorithm associated with the task 602 and the quality of the respective output of the task to determine if an autonomous driving mode is available for engagement. If a check 606 of the output 604 fails, the reason for the failure is communicated thereby enabling a human (e.g., a driver or remote operator) to resolve the issue. Generally, without checking for the availability of autonomous driving mode, an AV can command uncomfortable behaviors (e.g., abrupt steering action, accelerations, or decelerations) upon transition from a manual driving mode to an autonomous driving mode. Traditional techniques to control transitions are limited to reducing control authority or filtering the control commands during a transition from a manual driving mode to an autonomous driving mode. However, reducing control or filtering does not enable a smooth transition from a manual driving mode to an autonomous driving mode in view of a current operational state of the vehicle.

In embodiments, the evaluation of outputs 604 by the AutoReady checkers 606 includes one or more determinations. For example, the AutoReady checkers evaluate the outputs 604 to determine that a path from a planning system exists, the longitudinal acceleration and steering commands are within comfort thresholds, or that a vehicle state is within a controllers ratio of attraction given the controllers reference/constraints. An AutoReady Checker 606 also determines if acceleration and steering rates are within comfortable, predetermined thresholds. In examples, a respective predetermined threshold applicable to acceleration or steering rates can be defined based on a passenger profile.

In addition to evaluations executed as the AutoReady checker 606 for each respective task, temporal constraints can govern the availability of a transition from a manual driving mode to an autonomous driving mode as determined by a respective AutoReady checker. For example, an age associated with a control signal is evaluated to determine the availability of a transition from a manual driving mode to an autonomous driving mode. In this example, when a human driver manually engages in sharp steering for more than a predefined time limit, the AutoReady Checker 606 indicates a transition from a manual driving mode to an autonomous driving mode is unavailable. In another example, when a human driver repeatedly engages in sharp steering motions over a predefined time window, the AutoReady Checker 606 indicates that a transition from a manual driving mode to an autonomous driving mode is unavailable. Moreover, in another example, if an acceleration command in the direction of travel is above a predefined acceleration value, the AutoReady checker indicates that a transition from a manual driving mode to an autonomous driving mode is unavailable. In this example, the human driver operates the vehicle to cause a high rate of acceleration, and the autonomous system rejects a transition to an autonomous driving mode during the high rate of acceleration to prevent uncomfortable transitions to an autonomous driving mode. In embodiments, the acceleration is a predicted yaw acceleration.

In embodiments, when a request to engage autonomous driving mode is received, at block 608 it is determined if a transition from a manual driving mode to an autonomous driving mode is available. If an AutoReady checker 606 indicates that a transition from a manual driving mode to an autonomous driving mode is unavailable, process flow continues to blocks 610 and 612. At block 610, autonomous driving mode is rejected. At block 612, one or more reasons for the rejection of autonomous driving mode is communicated to a human driver or operator. In embodiments, an operator is located remotely from the AV. In some cases, the reasons for rejection of autonomous driving mode is communicated to a driver of the AV. Example communications with the driver or remote operator (if engaging auto remotely) include audio feedback indicating auto engagement attempt was rejected and/or a visual explanation rendered by a graphical user interface (GUI) to provide the driver or remote operator with actionable information. For example, audio feedback may be provided at the AV when auto engagement is attempted, alerting the driver or remote operator that engagement of autonomous driving mode was rejected via a series of beeps, chirps, or other audio tones. Audio feedback also includes digital speech that explains the rejection of autonomous mode in language understood by humans. In examples, visual feedback includes explanation rendered by one or more displays. At block 608, if all tasks indicate that autonomous driving mode is available according to the AutoReady Checkers 606 based on health information and output 604, process flow continues to block 614. At block 614, autonomous driving mode is enabled (e.g., a transition to an autonomous operation is allowed).

In examples, the present techniques identify one or more causes of rejecting the transition from the manual driving mode to the autonomous driving mode. Generally, a cause for rejecting the transition from the manual driving mode to the autonomous driving mode is based on the autonomous vehicle task output failing to satisfy an adaptive threshold. Accordingly, a cause for rejection of the autonomous mode engagement is autonomous vehicle task output (e.g., planning, perception, localization, and the like) being outside of expected values as indicated by the adaptive threshold.

FIG. 7 is a block diagram of an adaptive threshold generation system 700. Information sources for threshold generation includes a sensor 704 (e.g., one or more devices such as cameras 202a, LiDAR sensors 202b, radar sensors 202c, and microphones 202d of FIG. 2), a database 706 (e.g., memory 306 or storage component 308 of FIG. 3; database 410 of FIG. 4), a passenger profile 708, the autonomous vehicle 702 (e.g., an autonomous system that is the same as or similar to an autonomous system 202 and/or autonomous vehicle compute 400 of FIG. 4), adaptive threshold generator 710 (which monitors perception, trajectory planning, motion control, and the like), and an AutoReady system 600, or any combinations thereof.

When the autonomous system 702 receives a request 720 to transition into a fully or partially autonomous driving mode, the AutoReady system 600 determines if a transition from to the autonomous driving mode is available based on, at least in part, one or more adaptive thresholds. Adaptive thresholds can be generated based on sensor data 704, database 706, passenger profiles 708, a current operational state of the vehicle, or any combinations thereof. In examples, a passenger profile 708 is obtained by the adaptive threshold generator 710. The passenger profile can indicate, for example, a preference of the passenger with regard to maximum speeds, accelerations, decelerations, and steering angles. These preferences are used to calculate one or more adaptive thresholds, wherein the adaptive threshold enables a smooth transition from a manual driving to an autonomous driving. In examples, data associated with autonomous vehicle operation (e.g., sensor data 704, data stored in databases 706) are evaluated to determine one or more adaptive thresholds for comparison with at least one autonomous vehicle task output.

In some cases, an adaptive threshold generator 710 captures a current operational state of the AV. Generally, when transitioning to an autonomous driving mode, a current operational state of the AV is in manual driving mode (e.g., operation controlled by a human). The current operational state of the AV includes a state of a sensor, a state of a function, a state of a device, or a state of the autonomous system as operated by a human. In some cases, the current operational state includes a current perception state of the autonomous system (e.g. perception system 402), a current planning state of the autonomous system (e.g., a planning system 404), and a current set of control signals of the autonomous system (e.g., steering, braking, speed, acceleration, turning radius, and the like) in response to manual driving by a human. In examples, a current operational state of the AV includes a driving speed or turning angle, or both during manual driving by a human.

The adaptive threshold generator 710 monitors the current operational state of the AV 700. In response to changes in the current operational state of the AV 700, the adaptive threshold generator 710 updates or modifies the thresholds applied to the autonomous vehicle operation task outputs by the AutoReady system 600. In some cases, the autonomous vehicle operation task outputs include control signals that govern operation of the AV. In embodiments, the adaptive thresholds are generated during full or partial manual driving modes. In embodiments, the adaptive thresholds are calculated such that a transition from the manual driving mode (e.g., the current operational state) to the autonomous driving mode is smooth. In examples, a smooth transition is a change from a manual driving mode to an autonomous driving mode without jerk or sudden unintended acceleration.

Based on this current operational status, adaptive thresholds are generated that enable the AutoReady System to determine if a transition from a manual driving mode to an autonomous driving mode is available. If a task output 604 (FIG. 6) of the AutoReady system 600 exceeds or otherwise fails to satisfy an adaptive threshold for a respective autonomous vehicle operation task, the task 602 or AutoReady checker 606 (FIG. 6) indicates that autonomous driving mode is not available. For example, if the AV speed during manual driving (e.g., a current operational state) is 50 km/hr, the adaptive threshold for a transition from a manual driving mode to an autonomous driving mode is a speed at which the autonomous system can maintain at or near the current AV speed during manual driving. In this example, a preferred speed for the AV may be 30 km/hr; however, a sharp speed reduction from 50 km/hr to 30 km/hr may cause a collision by a following vehicle, or an otherwise jerky, unsmooth transition. In this example, the AutoReady check fails, and autonomous driving mode is unavailable for transition. In embodiments, the reason for the unavailability of autonomous driving mode is communicated using audio prompts, video detection, or occupant confirmation, or a combination of them.

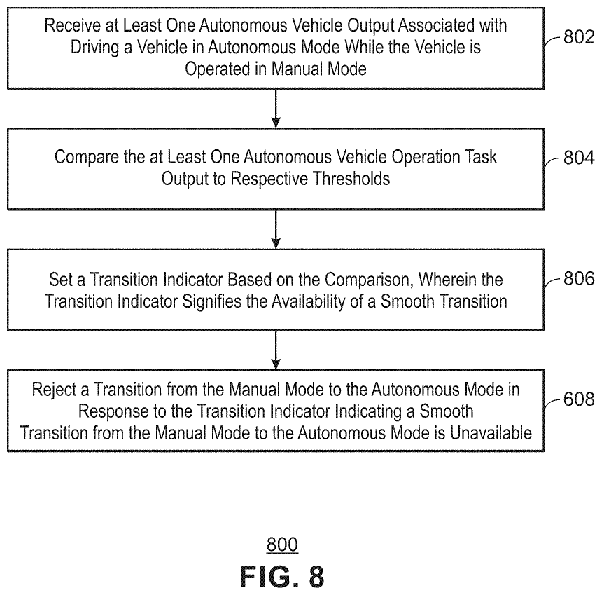

FIG. 8 is a block diagram of a process that enables autonomous driving mode engagement. In some embodiments, one or more of the steps described with respect to process 800 are performed (e.g., completely, partially, and/or the like) by autonomous system 202 (FIG. 2). Additionally, or alternatively, in some embodiments one or more steps described with respect to process 800 are performed (e.g., completely, partially, and/or the like) by another device or group of devices separate from or including autonomous system 202 (FIG. 2), such as AutoReady system 510 (FIG. 5), AutoReady System 600 (FIG. 6), and adaptive threshold generation system 700 (FIG. 7).

At block 802, at least one autonomous vehicle task output associated with driving a vehicle in autonomous driving mode while the vehicle is operated in manual driving mode is received. With continued reference to FIG. 4, autonomous vehicle task output includes, for example, output of a perception system 402, planning system 404, localization system 406, control system 408, database 410, or any combinations thereof.

At block 804, the at least one autonomous vehicle operation task output is compared to respective thresholds. In examples, at least one adaptive threshold is generated using an adaptive threshold generator 710 (FIG. 7). In some cases, the adaptive threshold is based on a current operation state of the AV.

At block 806, a transition indicator is set based on the comparison, wherein the transition indicator signifies the availability of a smooth transition. In embodiments, the transition indicator is a Boolean value that indicates whether a respective task approves a transition from a manual driving mode to an autonomous driving mode. If any transition indicator indicates a transition from a manual driving mode to an autonomous driving mode is unavailable, autonomous driving mode is disabled. In this manner, the present techniques evaluates the availability of autonomous mode driving at the task level to ensure that autonomous driving mode is engaged comfortably. This eliminates the jerky motion when transitioning from a manual driving mode to an autonomous driving mode.

At block 808, a transition from the manual driving mode to the autonomous driving mode is rejected in response to the transition indicator indicating a smooth transition from the manual driving mode to the autonomous driving mode is unavailable. In embodiments, the rejection of the transition from a manual driving mode to an autonomous driving mode is communicated to the driver. For example, a light, verbal indicator, audio message, of visual message is provided to the driver or remote operator. In some examples, the rejection is communicated using a Boolean indicator, always on during manual driving mode indicator which signifies if driver is able to engage auto mode. Generally, the AV communicates that the autonomous driving mode is not available using a not-ready status. In response to the not ready status, the driver or remote operator take one or more corrective actions. Corrective actions include, for examples, steering the AV so it is closer to a path or speed generated by the AV. Corrective actions further include accelerating or decelerating to more closely match the autonomous vehicle task output. In some examples, a message is provided that explains one or more reason(s) for failing to engage autonomous driving mode. Generally, a corrective action is any action that causes the current operational state of the AV to satisfy (e.g., fall within) ranges corresponding to the adaptive threshold. Accordingly, the present techniques ensure smooth and comfortable transitions from manual to autonomous driving modes. Further, the present techniques ensure safety and stability of tasks. Moreover, communicating the reason for disabling auto mode with operator, allowing corrective action to be taken.

In the foregoing description, aspects and embodiments of the present disclosure have been described with reference to numerous specific details that can vary from implementation to implementation. Accordingly, the description and drawings are to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction. Any definitions expressly set forth herein for terms contained in such claims shall govern the meaning of such terms as used in the claims. In addition, when we use the term “further comprising,” in the foregoing description or following claims, what follows this phrase can be an additional step or entity, or a sub-step/sub-entity of a previously-recited step or entity.

1. A system, comprising:
at least one processor; and
at least one memory storing instructions thereon that, when executed by the at least one processor, cause the at least one processor to:
receive at least one autonomous vehicle operation task output associated with driving a vehicle in autonomous driving mode in an environment while the vehicle is operated in manual driving mode in the environment;
compare the at least one autonomous vehicle operation task output to a respective threshold, wherein the respective threshold is adaptive based on a current operational state of the vehicle in the manual driving mode;
set a transition indicator based on the comparison, wherein the transition indicator signifies the availability of a smooth transition from the manual driving mode to the autonomous driving mode; and
reject a transition from the manual driving mode to the autonomous driving mode in response to the transition indicator indicating a smooth transition from the manual driving mode to the autonomous driving mode is unavailable.

2. The system of claim 1, wherein the one or more autonomous vehicle operation task outputs comprises data associated with path planning, and wherein comparing the path planning data to a respective threshold determines an existence of a path from a planner for which the transition to the path is smooth.

3. The system of claim 1, wherein the one or more autonomous vehicle operation task outputs comprises data associated with acceleration, and wherein comparing the acceleration data to a respective threshold determines that a transition from the manual driving mode to the autonomous driving mode according to the acceleration data is smooth.

4. The system of claim 1, wherein the one or more autonomous vehicle operation task outputs comprises data associated with steering, and comparing the steering data to a respective threshold determines that a transition from the manual driving mode to the autonomous driving mode according to the steering data is smooth.

5. The system of claim 1, wherein the transition indicator signifies that the vehicle cannot safely track a path traversed during manual driving mode.

6. The system of claim 1, wherein the operations further comprise providing feedback that the transition from a manual driving mode to an autonomous driving mode was rejected.

7. The system of claim 6, wherein the feedback is audio feedback.

8. The system of claim 6, wherein the feedback is visual feedback rendered on at least one display.

9. The system of claim 1, the operations further comprising rendering visual feedback that the transition from a manual driving mode to an autonomous driving mode was rejected, wherein the visual feedback identifies a cause of rejecting the transition from the manual driving mode to the autonomous driving mode.

10. The system of claim 1, the operations further comprising providing at least one instruction corresponding to a corrective action when the transition from the manual driving mode to the autonomous driving mode is rejected, wherein the corrective action is applied to the current operational state of the vehicle.

11. A method, comprising:
receiving, with at least one processor, at least one autonomous vehicle operation task output associated with driving a vehicle in autonomous driving mode in an environment while the vehicle is operated in manual driving mode in the environment;
comparing, with the at least one processor, the at least one autonomous vehicle operation task output to a respective threshold, wherein the respective threshold is adaptive based on a current operational state of the vehicle in the manual driving mode;
setting, with the at least one processor, a transition indicator based on the comparison, wherein the transition indicator signifies the availability of a smooth transition from the manual driving mode to the autonomous driving mode; and
rejecting, with the at least one processor, a transition from the manual driving mode to the autonomous driving mode in response to the transition indicator indicating a smooth transition from the manual driving mode to the autonomous driving mode is unavailable.

12. The method of claim 11, wherein the one or more autonomous vehicle operation task outputs comprises data associated with path planning, and wherein comparing the path planning data to a respective threshold determines an existence of a path from a planner for which the transition to the path is smooth.

13. The method of claim 11, wherein the one or more autonomous vehicle operation task outputs comprises data associated with acceleration, and wherein comparing the acceleration data to a respective threshold determines that a transition from the manual driving mode to the autonomous driving mode according to the acceleration data is smooth.

14. The method of claim 11, wherein the one or more autonomous vehicle operation task outputs comprises data associated with steering, and comparing the steering data to a respective threshold determines that a transition from the manual driving mode to the autonomous driving mode according to the steering data is smooth.

15. The method of claim 11, wherein the transition indicator signifies that the vehicle cannot safely track a path traversed during manual driving mode.

16. The method of claim 11, wherein the operations further comprise providing feedback that the transition from a manual driving mode to an autonomous driving mode was rejected.

17. The method of claim 11, the operations further comprising rendering visual feedback that the transition from a manual driving mode to an autonomous driving mode was rejected, wherein the visual feedback identifies a cause of rejecting the transition from the manual driving mode to the autonomous driving mode.

18. The method of claim 11, the operations further comprising providing at least one instruction corresponding to a corrective action when the transition from the manual driving mode to the autonomous driving mode is rejected, wherein the corrective action is applied to the current operational state of the vehicle.

19. At least one non-transitory storage media storing instructions that, when executed by at least one processor, cause the at least one processor to:
receive at least one autonomous vehicle operation task output associated with driving a vehicle in autonomous driving mode in an environment while the vehicle is operated in manual driving mode in the environment;
compare the at least one autonomous vehicle operation task output to a respective threshold, wherein the respective threshold is adaptive based on a current operational state of the vehicle in the manual driving mode;
set a transition indicator based on the comparison, wherein the transition indicator signifies the availability of a smooth transition from the manual driving mode to the autonomous driving mode; and
reject a transition from the manual driving mode to the autonomous driving mode in response to the transition indicator indicating a smooth transition from the manual driving mode to the autonomous driving mode is unavailable.

20. The at least one non-transitory storage media of claim 19, wherein the one or more autonomous vehicle operation task outputs comprises data associated with path planning, and wherein comparing the path planning data to a respective threshold determines an existence of a path from a planner for which the transition to the path is smooth.
